(19) United States
(12) Patent Application Publication
(10) Pub. No.: US 2017/0076579 A1
(43) Pub. Date: Mar. 16, 2017

(54) DEVICES FOR GENERATING SERVICE REQUESTS AND METHODS THEREOF

(71) Applicant: Noodoe Corporation, Taipei City (TW)

(72) Inventor: John C. Wang, Taipei City (TW)

(21) Appl. No.: 15/238,747

(22) Filed: Aug. 17, 2016

(30) Foreign Application Priority Data
Sep. 11, 2015 (TW) 104130025

(51) Int. Cl. G08B 21/22; H04W 4/06; H04W 52/02; G08B 5/38

(52) U.S. Cl. CPC G08B 21/22; G08B 5/38; H04W 4/06; H04W 52/0261

(57) ABSTRACT

Devices for generating service requests and methods thereof are provided. The device at least includes a wireless transceiver, a sensor, and a controller electrically coupled to the wireless transceiver and the sensor. The sensor detects the presence of an object. When the object is present, the controller determines whether the object is continuously present for a predefined interval. If so, the controller generates a first signal at least including a specific service ID, identification data corresponding to the device, and first content data, and wirelessly broadcasts the first signal via the wireless transceiver.

### BACKGROUND OF THE INVENTION

Field of the Invention

The disclosure relates generally to devices for generating service requests and methods thereof, and, more particularly to devices that can automatically generate a service request depending on whether an object is present, and wirelessly broadcast the service request, and methods thereof.

Description of the Related Art

In the service industry, the best way to increase customer satisfaction is by directly providing appropriate and immediate services to customers. For example, when a customer needs a specific service, such as ordering food, having their water refilled, or receiving the check, the customer always raises a hand to let the waiter noticed the customer's requests. In another example, when a customer is interested in a product on a display cabinet of a store, the customer will find a salesman to give the product a trial, and ask for related information, such as product function and price. However, during busy times, it is not easy to find a personnel, or the customer's requests cannot be handled in real-time, resulting in customer dissatisfaction.

Conventionally, wireless service bells have been deployed in some restaurants or stores. Customers can push a service bell set on the table or near by the product when they need a service. The service bell can wirelessly transmit signals to reception equipment set on a counter or it can be worn by a waiter, so that the customers' requirement can be known by the waiter without delay.

The wireless service bells can solve the requirement of finding a waiter for some customers. However, the customer who pushes the service bell always has an explicit requirement, or is indeed interested in the product. For some potential customers who are slightly attracted by the product, and not really understand the details of the product, they lack a motivation to directly push the service bell. These possible business opportunities may be lost if related personnel ignore the moment when the customers stay in front of the product.

### BRIEF SUMMARY OF THE INVENTION

Devices for generating service requests and methods thereof are provided, wherein a device can detect an object to automatically generate a service request, and wirelessly broadcast the service request.

In an embodiment of a device for generating service requests comprises a wireless transceiver, a sensor, and a controller electrically coupled to the wireless transceiver and the sensor. The sensor detects the presence of an object. When the object is present, the controller determines whether the object is continuously present for a predefined interval. When the object is continuously present for the predefined interval, the controller generates a first signal comprising a specific service ID, identification data corresponding to the device, and first content data, and wirelessly broadcasts the first signal via the wireless transceiver.

An embodiment of a method for generating service requests, the presence of an object is detected by a sensor. When the object is present, it is determined whether the object is continuously present for a predefined interval. When the object is continuously present for the predefined interval, a first signal comprising a specific service ID, identification data corresponding to the device, and first content data is generated, and the first signal is wirelessly broadcasted via the wireless transceiver.

In some embodiments, the device for generating service requests further comprises a switch. The controller determines whether the switch is triggered or not. When the switch is triggered, the controller generates a second signal comprising the specific service ID, the identification data corresponding to the device, and second content data, and wirelessly broadcasts the second signal via the wireless transceiver.

In some embodiments, the device for generating service requests further comprises a light emitting unit. When the switch is triggered, the controller instructs the light emitting unit to emit lights, or instructs the light emitting unit to blink at a specific frequency. When the switch is triggered again, the controller instructs the light emitting unit to stop emitting lights or blinking.

In some embodiments, an accumulated time is calculated after the switch is triggered, and when the accumulated time is greater than a predefined time value, and the switch is not triggered again, the controller re-generates the second signal, and wirelessly broadcasts the second signal via the wireless transceiver.

In some embodiments, the device for generating service requests further comprises at least one motion sensor for detecting a motion or posture. The controller determines whether the detected motion or posture conforms to a specific motion or posture. When the detected motion or posture conforms to the specific motion or posture, the controller generates a third signal comprising the specific service ID, the identification data corresponding to the device, and third content data, and wirelessly broadcasts the third signal via the wireless transceiver.

In some embodiments, the device for generating service requests further comprises a power unit. The controller obtains a remaining battery level corresponding to the power unit, and determines whether the remaining battery level is less than a predefined level. When the remaining battery level is less than the predefined level, the controllers generates a fourth signal comprising the specific service ID, the identification data corresponding to the device, and fourth content data, and wirelessly broadcasts the fourth signal via the wireless transceiver.

In some embodiments, a target electronic device wirelessly receives the first signal via a wireless transceiver, and determines whether the specific service ID in the first signal conforms to a predefined service ID. When the specific service ID conforms to the predefined service ID, the first content in the first signal is presented via the target electronic device.

In some embodiments, the wireless transceiver of the device and the wireless transceiver of the target electronic device respectively have a peripheral mode and a central mode, wherein the device broadcasts the first signal in the peripheral mode, and the target electronic device receives the first signal in the central mode.

In some embodiments, the device for generating service requests further comprises a light emitting unit. After the first signal is broadcasted, the controller instructs the light emitting unit to emit lights, or instructs the light emitting unit to blink at a specific frequency.

In some embodiments, the device for generating service requests further comprises a reading unit. After the first signal is broadcasted, the controller instructs the reading unit to be active for reading an identify code from a data carrier.

Methods for generating service requests may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a device for generating service requests of the invention;

FIG. 2 is a schematic diagram illustrating another embodiment of a device for generating service requests of the invention;

FIG. 3 is a schematic diagram illustrating another embodiment of a device for generating service requests of the invention;

FIG. 4 is a schematic diagram illustrating another embodiment of a device for generating service requests of the invention;

FIG. 5 is a schematic diagram illustrating another embodiment of a device for generating service requests of the invention;

FIG. 6 is a schematic diagram illustrating another embodiment of a device for generating service requests of the invention;

FIG. 7 is a schematic diagram illustrating an embodiment of a target electronic device for wirelessly receiving signals generated by a device for generating service requests of the invention;

FIG. 8 is a flowchart of an embodiment of a method for generating service requests of the invention;

FIG. 9 is a flowchart of an embodiment of a method for receiving signals by a target electronic device of the invention;

FIG. 10 is a flowchart of another embodiment of a method for generating service requests of the invention;

FIG. 11 is a flowchart of another embodiment of a method for generating service requests of the invention;

FIG. 12 is a flowchart of an embodiment of a method for triggering a switch of the invention;

FIG. 13 is a flowchart of another embodiment of a method for generating service requests of the invention; and

FIG. 14 is a flowchart of another embodiment of a method for generating service requests of the invention.

### DETAILED DESCRIPTION OF THE INVENTION

Devices for generating service requests and methods thereof are provided.

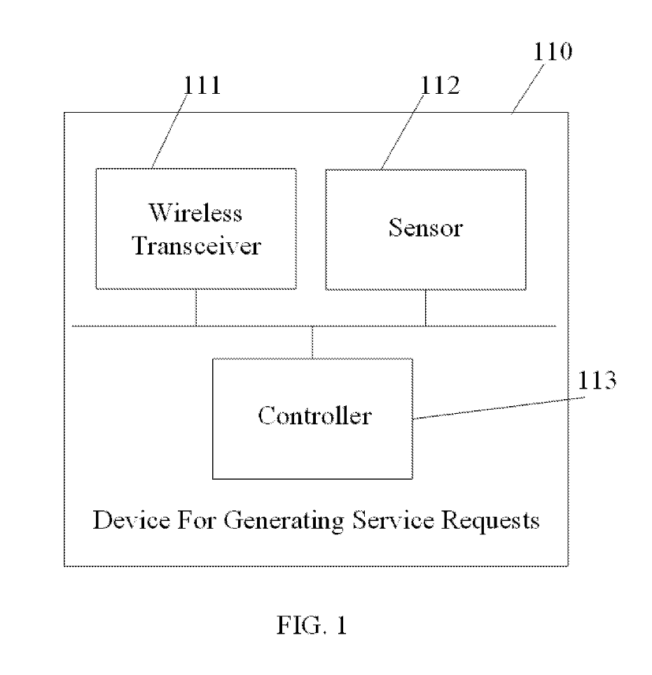

FIG. 1 is a schematic diagram illustrating an embodiment of a device for generating service requests of the invention. As shown in FIG. 1, the device for generating service requests 110 comprises a wireless transceiver 111, a sensor 112, and a controller 113 electrically coupled to the wireless transceiver 111 and the sensor 112. The wireless transceiver 111 can wirelessly receive and transmit signals. In some embodiments, the wireless transceiver 111 can be a radio transceiver for broadcasting or receiving data in a specific frequency range, such as VHF or UHF. In some embodiments, the wireless transceiver 111 can be a network connecting unit for transmitting and receiving data via a wireless network, such as a Wi-Fi or a Bluetooth network, and/or connecting to any electronic device having wireless network connecting capabilities. It is understood that, in some embodiments, the wireless transceiver 111 may be a network connecting unit implemented with a low-power consumption technology, such as Bluetooth Smart technology. The wireless transceiver 111 has two modes, such as a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the wireless transceiver 111 is in the peripheral mode. In other words, the wireless transceiver 111 has data broadcasting capabilities, and the wireless transceiver 111 cannot actively connect to other electronic devices, wherein the wireless transceiver 111 can be passively connected to other electronic devices. The sensor 112 can detect the presence of an object. It is understood that, in some embodiments, the sensor 112 may be an optical component, an ultrasonic sensor, a radar, and/or a camera. It is noted that, the object can be various according to different applications and requirements. In some embodiments, the object can be the eye of a user. The controller 113 can control related operations of hardware and software in the device for generating service requests 110, and perform the methods for generating service requests of the present invention to instruct the wireless transceiver 111 to act according to the detection result of the sensor 112, which will be discussed later.

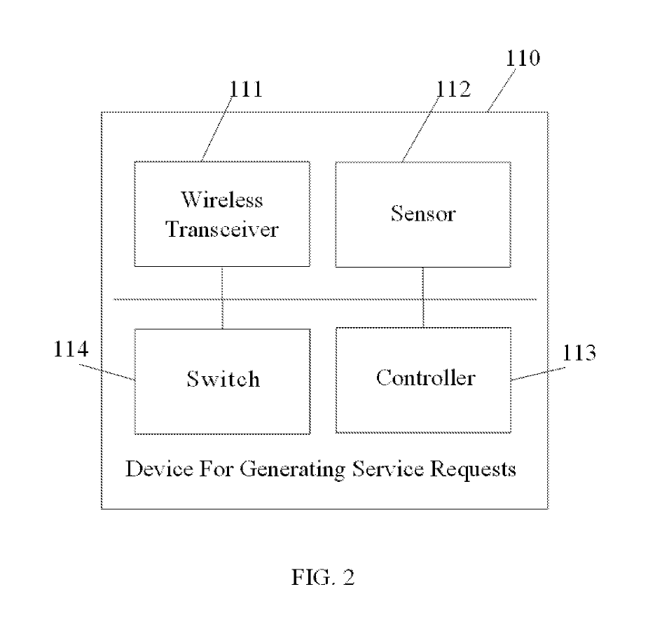

FIG. 2 is a schematic diagram illustrating another embodiment of a device for generating service requests of the invention. As shown in FIG. 2, the device for generating service requests 110 comprises a wireless transceiver 111, a sensor 112, a switch 114, and a controller 113 electrically coupled to the wireless transceiver 111, the sensor 112, and the switch 114. The functions of the wireless transceiver 111 and the sensor 112 have been discussed in FIG. 1, and omitted here. It is understood that, the switch 114 can be implemented using any manner. The controller 113 can control related operations of hardware and software in the device for generating service requests 110, and perform the methods for generating service requests of the present invention to instruct the wireless transceiver 111 to act according to the detection result of the sensor 112 and/or whether the switch 114 is triggered or not, which will be discussed later.

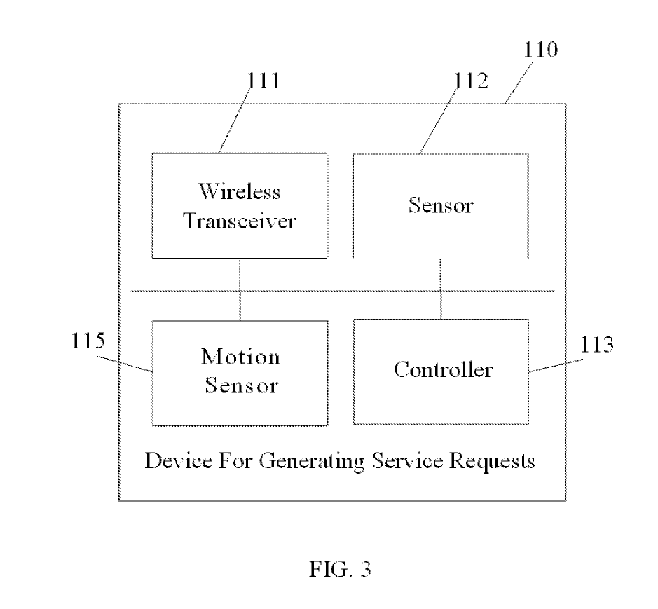

FIG. 3 is a schematic diagram illustrating another embodiment of a device for generating service requests of the invention. As shown in FIG. 3, the device for generating service requests 110 comprises a wireless transceiver 111, a sensor 112, a motion sensor 115, and a controller 113 electrically coupled to the wireless transceiver 111, the sensor 112, and the motion sensor 115. The functions of the wireless transceiver 111 and the sensor 112 have been discussed in FIG. 1, and omitted here. It is understood that, the motion sensor 115 can detect a motion and/or posture corresponding to the device for generating service requests 110 or a specific component of the device for generating service requests 110. In some embodiments, the motion sensor 115 may be an accelerometer for generating information of velocity and displacement when the device moves. In another example, the motion sensor 115 may be a Gyro sensor for generating information of angular acceleration when the device moves. It is noted that, the above sensors are only examples of the present application, and the present invention is not limited thereto. Any sensor that can detect the motion and/or posture of the device for generating service requests 110 or a specific component of the device for generating service requests 110 can be applied in the present invention. The controller 113 can control related operations of hardware and software in the device for generating service requests 110, and perform the methods for generating service requests of the present invention to instruct the wireless transceiver 111 to act according to the detection result of the sensor 112 and/or the detection result of the motion sensor 115, which will be discussed later.

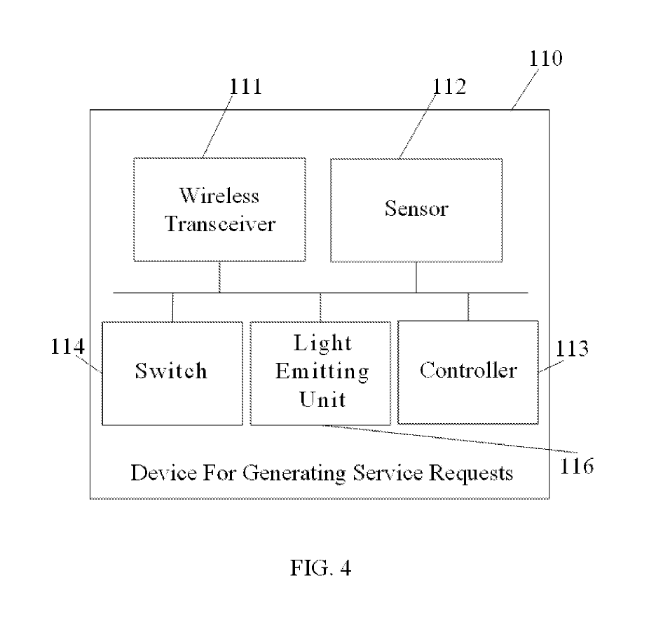

FIG. 4 is a schematic diagram illustrating another embodiment of a device for generating service requests of the invention. As shown in FIG. 4, the device for generating service requests 110 comprises a wireless transceiver 111, a sensor 112, a switch 114, a light emitting unit 116, and a controller 113 electrically coupled to the wireless transceiver 111, the sensor 112, the switch 114, and the light emitting unit 116. The functions of the wireless transceiver 111, the sensor 112, and the switch 114 have been discussed in FIGS. 1 and 2, and omitted here. In some embodiments, the light emitting unit 116 may be a LED. The controller 113 can control related operations of hardware and software in the device for generating service requests 110, and perform the methods for generating service requests of the present invention to instruct the wireless transceiver 111 and the light emitting unit 116 to act according to the detection result of the sensor 112 and/or whether the switch 114 is triggered or not, which will be discussed later.

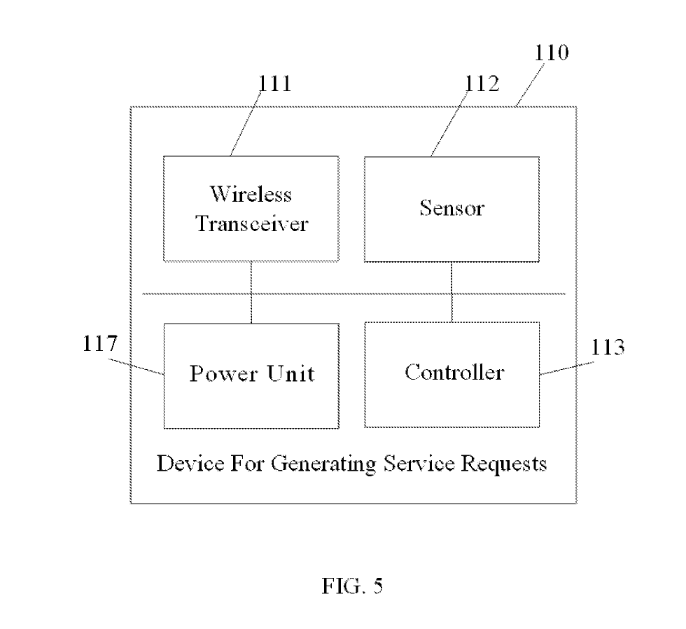

FIG. 5 is a schematic diagram illustrating another embodiment of a device for generating service requests of the invention. As shown in FIG. 5, the device for generating service requests 110 comprises a wireless transceiver 111, a sensor 112, a power unit 117, and a controller 113 electrically coupled to the wireless transceiver 111, the sensor 112, and the power unit 117. The functions of the wireless transceiver 111 and the sensor 112 have been discussed in FIG. 1, and omitted here. The power unit 117 provides power required for operating the device for generating service requests 110. The controller 113 can control related operations of hardware and software in the device for generating service requests 110. The controller 113 can obtain a remaining battery level corresponding to the power unit 117 from the power unit 117, and perform the methods for generating service requests of the present invention to instruct the wireless transceiver 111 to act according to the detection result of the sensor 112 and/or the remaining battery level corresponding to the power unit 117, which will be discussed later.

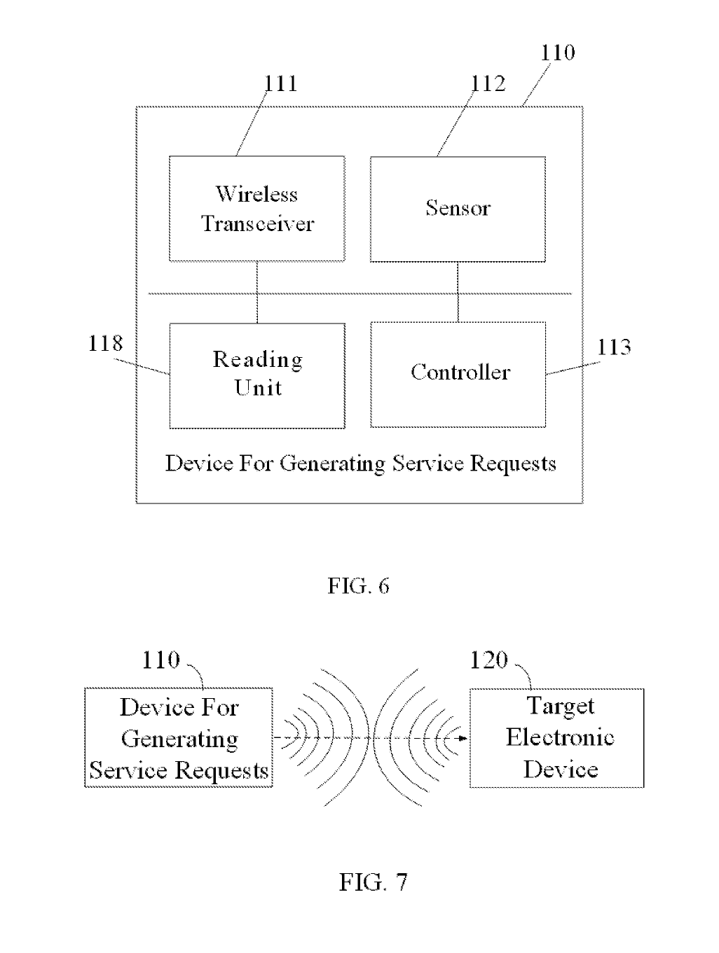

FIG. 6 is a schematic diagram illustrating another embodiment of a device for generating service requests of the invention. As shown in FIG. 6, the device for generating service requests 110 comprises a wireless transceiver 111, a sensor 112, a reading unit 118, and a controller 113 electrically coupled to the wireless transceiver 111, the sensor 112, and the reading unit 118. The functions of the wireless transceiver 111 and the sensor 112 have been discussed in FIG. 1, and omitted here. In some embodiments, the reading unit 118 may be a RFID reader for reading an identify code. In some embodiments, the reading unit 118 may be a contactless reading unit for communicating with a contactless communication unit to obtain an identify code according to a contactless communication protocol, such as NFC, TransferJet, or Zoosh. The controller 113 can control related operations of hardware and software in the device for generating service requests 110, and perform the methods for generating service requests of the present invention to instruct the wireless transceiver 111 and the reading unit 118 to act according to the detection result of the sensor 112, which will be discussed later.

FIG. 7 is a schematic diagram illustrating an embodiment of a target electronic device for wirelessly receiving signals generated by a device for generating service requests of the invention. As shown in FIG. 7, the device for generating service requests 110 can wirelessly broadcast a signal. A target electronic device 120 can wirelessly receive the signal broadcasted by the device for generating service requests 110, and perform subsequent processes according to the signal, which will be discussed later. In some embodiments, the target electronic device 120 may be a computer or a portable device, such as a mobile phone, a smart phone, a PDA (Personal Digital Assistant), a GPS (Global Positioning System), a notebook, a tablet computer, or a wearable device. It is noted that, the target electronic device 120 can have a wireless transceiver for wirelessly receiving the signal broadcasted by the device for generating service requests 110. Similarly, in some embodiments, the wireless transceiver can be a radio transceiver for broadcasting or receiving data in a specific frequency range, such as VHF or UHF. In some embodiments, the wireless transceiver can be a network connecting unit for transmitting and receiving data via a wireless network, such as a Wi-Fi or a Bluetooth network, and/or connecting to any electronic device having wireless network connecting capabilities. It is understood that, in some embodiments, the wireless transceiver may have a network connecting unit implemented with a low-power consumption technology, such as Bluetooth Smart technology. The network connecting unit has two modes, such as a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the network connecting unit of the target electronic device is in the central mode.

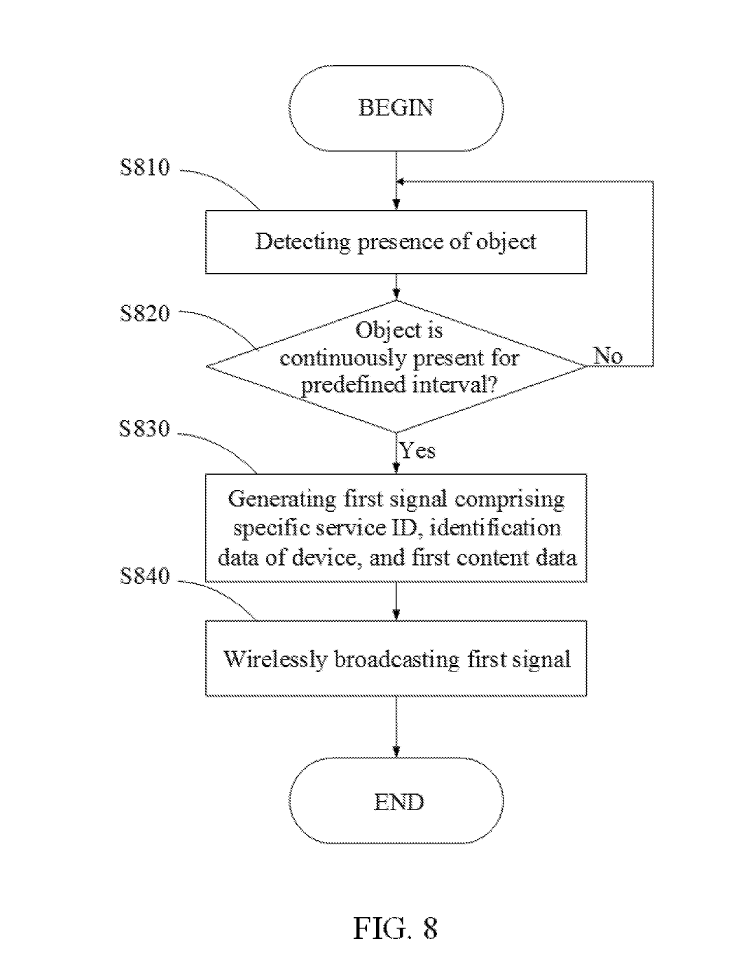

FIG. 8 is a flowchart of an embodiment of a method for generating service requests of the invention. The method for generating service requests can be used in the above device for generating service requests.

In step S810, the presence of an object is detected by a sensor. It is understood that, in some embodiments, the sensor may be an optical component, an ultrasonic sensor, a radar, and/or a camera. It is noted that, the object can be various according to different applications and requirements. In some embodiments, the object can be the eye of a user. When the presence of the object is detected, in step S820, it is determined whether the object is continuously present for a predefined interval. It is noted that, the predefined interval can be determined according to various requirements and applications. When the object is not continuously present for the predefined interval (No in step S820), the procedure returns to step S810. When the object is continuously present for the predefined interval (Yes in step S820), in step S830, a first signal is generated. The first signal comprises a specific service ID, identification data corresponding to the device, and first content data. In some cases, the first content can indicate that a potential service request is generated by the device. Then, in step S840, the first signal is wirelessly broadcasted via a wireless transceiver. It is understood that, in some embodiments, the wireless transceiver can wirelessly receive and transmit signals. In some embodiments, the wireless transceiver can be a radio transceiver for broadcasting or receiving data in a specific frequency range, such as VHF or UHF. In some embodiments, the wireless transceiver can be a network connecting unit for transmitting and receiving data via a wireless network, such as a Wi-Fi or a Bluetooth network, and/or connecting to any electronic device having wireless network connecting capabilities. It is understood that, in some embodiments, the wireless transceiver may be a network connecting unit implemented with a low-power consumption technology, such as Bluetooth Smart technology. The wireless transceiver has two modes, such as a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the wireless transceiver is in the peripheral mode. In other words, the wireless transceiver has data broadcasting capabilities, and the wireless transceiver cannot actively connect to other electronic devices, wherein the wireless transceiver can be passively connected to other electronic devices. It is understood that, in some embodiments, after the first signal is broadcasted, the controller of the device can instruct a light emitting unit to emit lights, or instruct the light emitting unit to blink at a specific frequency. It is noted that, the emitting or blinking lights will further increase the customers' attention on a product. Related personnel can be also prompted with the request by the emitting or blinking lights.

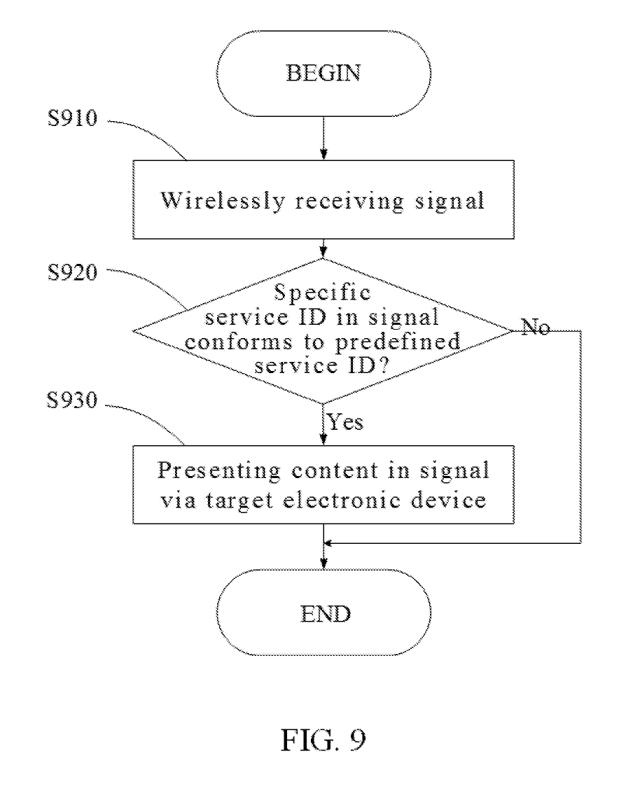

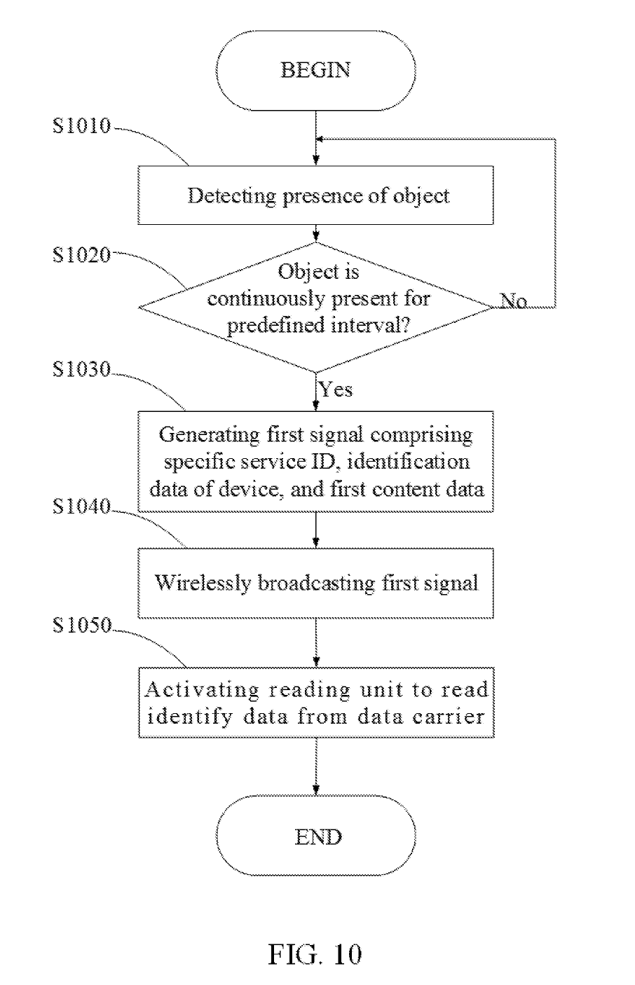

FIG. 9 is a flowchart of an embodiment of a method for receiving signals by a target electronic device of the invention.

In step S910, a target electronic device wirelessly receives a signal via a wireless transceiver. Similarly, in some embodiments, the wireless transceiver can wirelessly receive and transmit signals. In some embodiments, the wireless transceiver can be a radio transceiver for broadcasting or receiving data in a specific frequency range, such as VHF or UHF. In some embodiments, the wireless transceiver can be a network connecting unit for transmitting and receiving data via a wireless network, such as a Wi-Fi or a Bluetooth network, and/or connecting to any electronic device having wireless network connecting capabilities. It is understood that, in some embodiments, the wireless transceiver may be a network connecting unit implemented with a low-power consumption technology, such as Bluetooth Smart technology. The wireless transceiver has two modes, such as a central mode and a peripheral mode. In some embodiments, the wireless transceiver of the target electronic device wirelessly receives signals is in the central mode. Then, in step S920, it is determined whether a specific service ID in the signal conforms to a predefined service ID. When the specific service ID in the signal does not conform to the predefined service ID (No in step S920), the procedure is completed. When the specific service ID in the signal conforms to the predefined service ID (Yes in step S920), in step S930, a content in the signal is presented via the target electronic device. It is understood that, in some embodiments, the content can be displayed via a display unit of the target electronic device. In some embodiments, the content can be output via a sound output unit of the target electronic device. It is noted that, the above presentations of content are examples of the present application, and the present is not limited thereto.

FIG. 10 is a flowchart of another embodiment of a method for generating service requests of the invention. The method for generating service requests can be used in the above device for generating service requests.

In step S1010, the presence of an object is detected by a sensor. Similarly, in some embodiments, the sensor may be an optical component, an ultrasonic sensor, a radar, and/or a camera. It is noted that, the object can be various according to different applications and requirements. In some embodiments, the object can be the eye of a user. When the presence of the object is detected, in step S1020, it is determined whether the object is continuously present for a predefined interval. It is noted that, the predefined interval can be determined according to various requirements and applications. When the object is not continuously present for the predefined interval (No in step S1020), the procedure returns to step S1010. When the object is continuously present for the predefined interval (Yes in step S1020), in step S1030, a first signal is generated. The first signal comprises a specific service ID, identification data corresponding to the device, and first content data. Then, in step S1040, the first signal is wirelessly broadcasted via a wireless transceiver. Similarly, in some embodiments, the wireless transceiver can wirelessly receive and transmit signals. In some embodiments, the wireless transceiver can be a radio transceiver for broadcasting or receiving data in a specific frequency range, such as VHF or UHF. In some embodiments, the wireless transceiver can be a network connecting unit for transmitting and receiving data via a wireless network, such as a Wi-Fi or a Bluetooth network, and/or connecting to any electronic device having wireless network connecting capabilities. It is understood that, in some embodiments, the wireless transceiver may be a network connecting unit implemented with a low-power consumption technology, such as Bluetooth Smart technology. The wireless transceiver has two modes, such as a central mode and a peripheral mode. In some embodiments, the wireless transceiver is in the peripheral mode. In other words, the wireless transceiver has data broadcasting capabilities, and the wireless transceiver cannot actively connect to other electronic devices, wherein the wireless transceiver can be passively connected to other electronic devices. After the first signal is broadcasted, in step S1050, a reading unit is instructed to be active for reading an identify code from a data carrier. It is understood that, in some embodiments, the reading unit may be a RFID reader for reading an identify code. In some embodiments, the reading unit may be a contactless reading unit for communicating with a contactless communication unit to obtain an identify code according to a contactless communication protocol, such as NFC, TransferJet, or Zoosh. For example, after a waiter equipped with the target electronic device receives the signal wirelessly broadcasted by the device for generating service requests, the waiter can use a data carrier, such as a card storing the identify code to touch the device for generating service requests, such that the reading unit of the device for generating service requests reads the identify code from the data carrier. In this way, the person who responded to the service request generated by the device for generating service requests can be known according to the identify code. It is understood that, in some embodiments, related data, such as the type and generation time corresponding to the signal generated by the device for generating service requests, the identify code corresponding to the person who responded to the service request, and the time when the identify code is received can be recorded and managed, or transmitted to other devices for further evaluations.

Similarly, in some embodiments, after the first signal is broadcasted, the controller of the device can instruct a light emitting unit to emit lights, or instruct the light emitting unit to blink at a specific frequency. It is noted that, the emitting or blinking lights will further increase the customers' attention on a product. Related personnel can be also prompted with the request by the emitting or blinking lights.

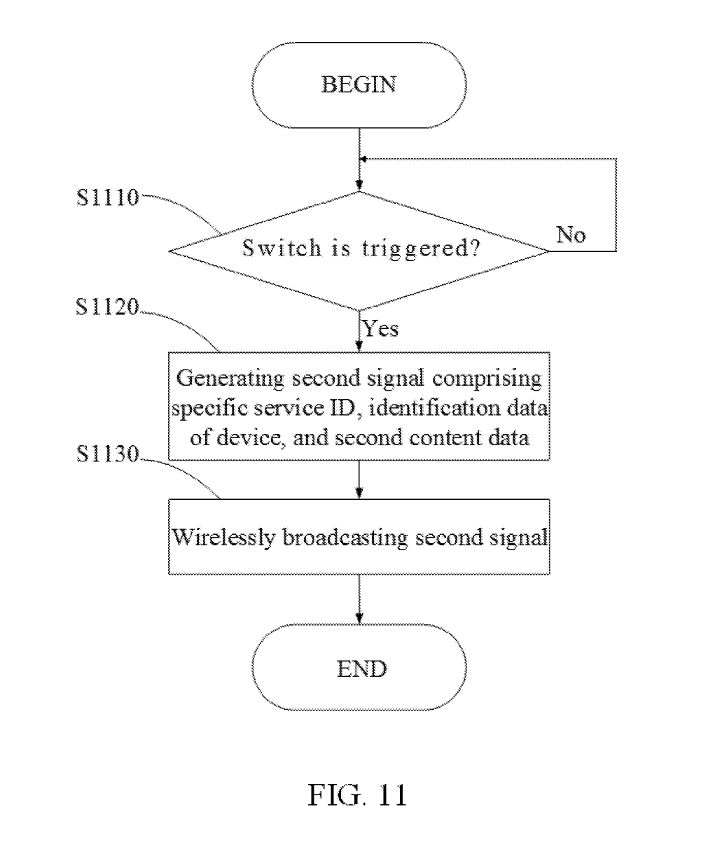

FIG. 11 is a flowchart of an embodiment of a method for generating service requests of the invention. The method for generating service requests can be used in the above device for generating service requests.

In step S1110, it is determined whether a switch of the device for generating service requests is triggered or not. It is noted that, the switch can be implemented using any manner. When the switch is not triggered (No in step S1110), the procedure remains at step S1110. When the switch is triggered (Yes in step S1110), in step S1120, a second signal is generated. The second signal comprises a specific service ID, identification data corresponding to the device, and second content data. It is noted that, in some embodiments, the second content is different that the first content in FIG. 8. In some cases, the second content can indicate that a definite service request is generated by the device. Then, in step S1130, the second signal is wirelessly broadcasted via a wireless transceiver. Similarly, in some embodiments, the wireless transceiver can wirelessly receive and transmit signals. In some embodiments, the wireless transceiver can be a radio transceiver for broadcasting or receiving data in a specific frequency range, such as VHF or UHF. In some embodiments, the wireless transceiver can be a network connecting unit for transmitting and receiving data via a wireless network, such as a Wi-Fi or a Bluetooth network, and/or connecting to any electronic device having wireless network connecting capabilities. It is understood that, in some embodiments, the wireless transceiver may be a network connecting unit implemented with a low-power consumption technology, such as Bluetooth Smart technology. The wireless transceiver has two modes, such as a central mode and a peripheral mode. In some embodiments, the wireless transceiver is in the peripheral mode. In other words, the wireless transceiver has data broadcasting capabilities, and the wireless transceiver cannot actively connect to other electronic devices, wherein the wireless transceiver can be passively connected to other electronic devices.

It is understood that, in some embodiments, after the switch is triggered, the controller of the device can instruct a light emitting unit to emit lights, or instruct the light emitting unit to blink at a specific frequency. When the switch is triggered again, the controller instructs the light emitting unit to stop emitting lights or blinking. It is noted that, in some embodiments, the embodiments of FIGS. 8 and 11 can be integrated. In other words, the device for generating service requests can generate different types of signals according to different manners.

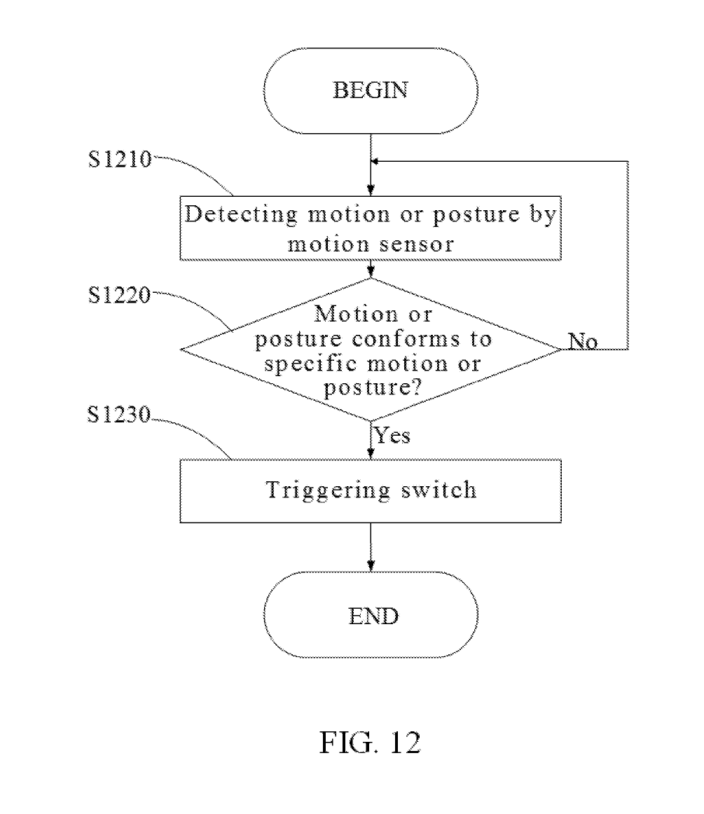

It is understood that, in some embodiments, the switch of the device for generating service requests can be implemented by at least one motion sensor. FIG. 12 is a flowchart of an embodiment of a method for triggering a switch of the invention. In step S1210, a motion or posture corresponding to the device for generating service requests or a specific component of the device for generating service requests is detected by at least one motion sensor. In some embodiments, the motion sensor may be an accelerometer for generating information of velocity and displacement when the device moves. In some embodiments, the motion sensor may be a Gyro sensor for generating information of angular acceleration when the device moves. It is noted that, the above sensors are only examples of the present application, and the present invention is not limited thereto. Any sensor that can detect the motion and/or posture of the device for generating service requests or a specific component of the device for generating service requests can be applied in the present invention. In step S1220, it is determined whether the detected motion or posture conforms to a specific motion or posture. When the detected motion or posture does not conform to the specific motion or posture (No in step S1220), the procedure returns to step S1210. When the detected motion or posture conforms to the specific motion or posture (Yes in step S1220), in step S1230, the switch of the device for generating service requests triggered.

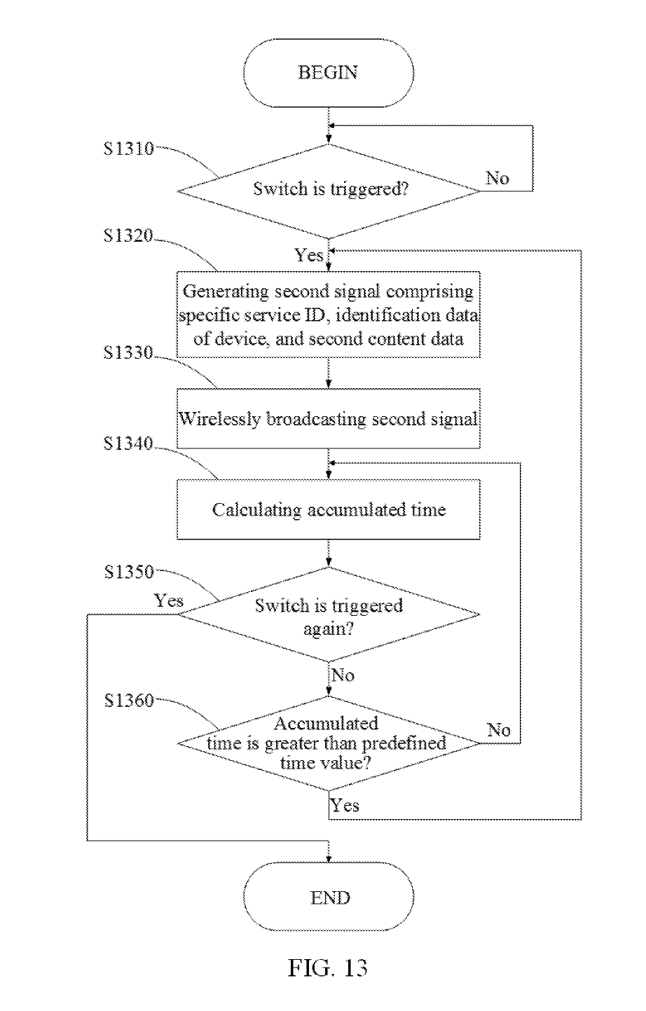

FIG. 13 is a flowchart of an embodiment of a method for generating service requests of the invention. The method for generating service requests can be used in the above device for generating service requests.

In step S1310, it is determined whether a switch of the device for generating service requests is triggered or not. It is noted that, the switch can be implemented using any manner. When the switch is not triggered (No in step S1310), the procedure remains at step S1310. When the switch is triggered (Yes in step S1310), in step S1320, a second signal is generated. The second signal comprises a specific service ID, identification data corresponding to the device, and second content data. It is noted that, in some embodiments, the second content is different that the first content in FIG. 8. In some cases, the second content can indicate that a definite service request is generated by the device. Then, in step S1330, the second signal is wirelessly broadcasted via a wireless transceiver. Similarly, in some embodiments, the wireless transceiver can wirelessly receive and transmit signals. In some embodiments, the wireless transceiver can be a radio transceiver for broadcasting or receiving data in a specific frequency range, such as VHF or UHF. In some embodiments, the wireless transceiver can be a network connecting unit for transmitting and receiving data via a wireless network, such as a Wi-Fi or a Bluetooth network, and/or connecting to any electronic device having wireless network connecting capabilities. It is understood that, in some embodiments, the wireless transceiver may be a network connecting unit implemented with a low-power consumption technology, such as Bluetooth Smart technology. The wireless transceiver has two modes, such as a central mode and a peripheral mode. In some embodiments, the wireless transceiver is in the peripheral mode. In other words, the wireless transceiver has data broadcasting capabilities, and the wireless transceiver cannot actively connect to other electronic devices, wherein the wireless transceiver can be passively connected to other electronic devices. After the second signal is broadcasted, in step S1340, an accumulated time is calculated. In step S1350, it is determined whether the switch is triggered again. When the switch is triggered again (Yes in step S1350), the procedure is completed. When the switch is not triggered again (No in step S1350), in step S1360, it is determined whether the accumulated time is greater than a predefined time value. It is noted that, the predefined time value can be set according to different applications and requirements. When the accumulated time is not greater than the predefined time value (No in step S1360), the procedure returns to step S1340. When the accumulated time is greater than the predefined time value (Yes in step S1360), the procedure returns to step S1320. In other words, the device for generating service requests will re-generate the second signal.

Similarly, in some embodiments, after the switch is triggered, the controller of the device can instruct a light emitting unit to emit lights, or instruct the light emitting unit to blink at a specific frequency. When the switch is triggered again, the controller instructs the light emitting unit to stop emitting lights or blinking.

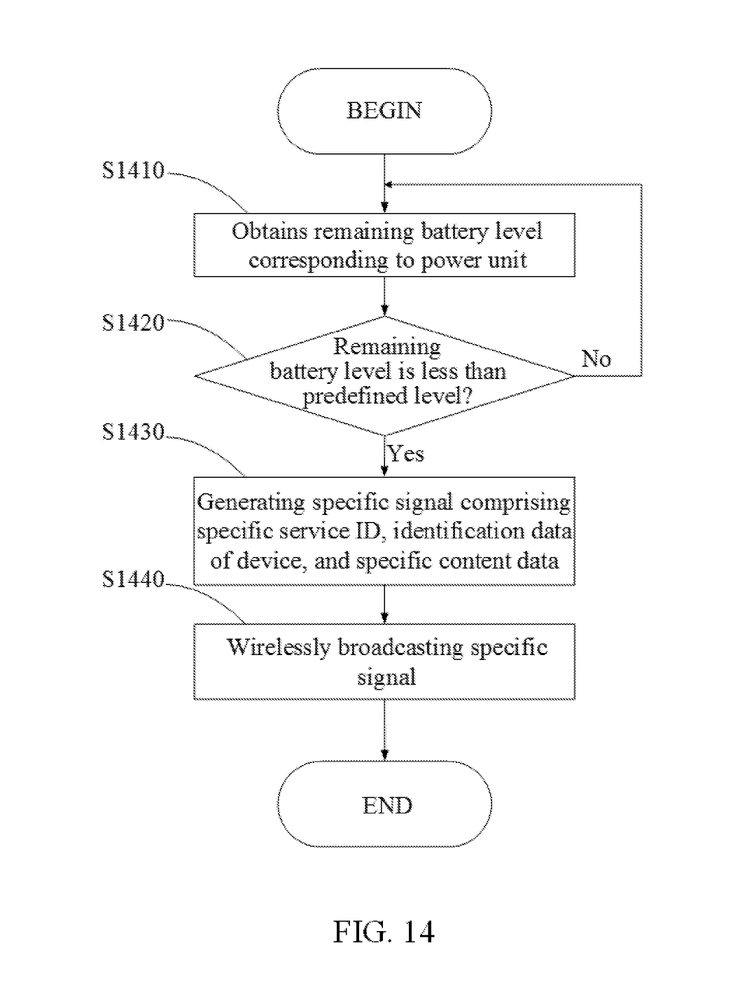

FIG. 14 is a flowchart of an embodiment of a method for generating service requests of the invention. The method for generating service requests can be used in the above device for generating service requests.

In step S1410, a remaining battery level corresponding to a power unit of the device for generating service requests is obtained. In step S1420, it is determined whether the remaining battery level is less than a predefined level. When the remaining battery level is not less than the predefined level (No in step S1420), the procedure returns to step S1410. When the remaining battery level is less than the predefined level (Yes in step S1420), in step S1430, a specific signal is generated. The specific signal comprises a specific service ID, identification data corresponding to the device, and specific content data. It is noted that, in some embodiments, the specific content is different that the first content in FIG. 8 and the second content in FIG. 11. In some cases, the specific content can indicate that the device for generating service requests needs to be charged. Then, in step S1440, the specific signal is wirelessly broadcasted via a wireless transceiver. Similarly, in some embodiments, the wireless transceiver can wirelessly receive and transmit signals. In some embodiments, the wireless transceiver can be a radio transceiver for broadcasting or receiving data in a specific frequency range, such as VHF or UHF. In some embodiments, the wireless transceiver can be a network connecting unit for transmitting and receiving data via a wireless network, such as a Wi-Fi or a Bluetooth network, and/or connecting to any electronic device having wireless network connecting capabilities. It is understood that, in some embodiments, the wireless transceiver may be a network connecting unit implemented with a low-power consumption technology, such as Bluetooth Smart technology. The wireless transceiver has two modes, such as a central mode and a peripheral mode. In some embodiments, the wireless transceiver is in the peripheral mode. In other words, the wireless transceiver has data broadcasting capabilities, and the wireless transceiver cannot actively connect to other electronic devices, wherein the wireless transceiver can be passively connected to other electronic devices.

Similarly, in some embodiments, after the specific signal is broadcasted, the controller of the device can instruct a light emitting unit to emit lights, or instruct the light emitting unit to blink at a specific frequency. It is noted that, in some embodiments, the embodiments of FIGS. 8, 11, and/or 14 can be integrated. In other words, the device for generating service requests can generate different types of signals according to different manners.

Therefore, the devices for generating service requests and methods thereof of the present invention can detect an object to automatically generate a service request, and wirelessly broadcast the service request, thereby improving the efficiency of request generation, and further increasing the business value and satisfactory when using related services. Further, related service data can be recorded and provided for further evaluation, thereby accomplishing the objective of information management.

Methods for generating service requests, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A device for generating service requests, comprising:
a wireless transceiver;
a sensor for detecting the presence of an object; and
a controller electrically coupled to the wireless transceiver and the sensor, for determining whether the object is continuously present for a predefined interval when the object is present, generating a first signal comprising a specific service ID, identification data corresponding to the device, and first content data when the object is continuously present for the predefined interval, and wirelessly broadcasting the first signal via the wireless transceiver.

2. The device of claim 1, further comprising a switch, wherein the controller determines whether the switch is triggered or not, when the switch is triggered, the controller generates a second signal comprising the specific service ID, the identification data corresponding to the device, and second content data, and wirelessly broadcasts the second signal via the wireless transceiver.

3. The device of claim 2, further comprising a light emitting unit, wherein when the switch is triggered, the controller instructs the light emitting unit to emit lights, or instructs the light emitting unit to blink at a specific frequency, and when the switch is triggered again, the controller instructs the light emitting unit to stop emitting lights or blinking.

4. The device of claim 2, wherein the controller calculates an accumulated time after the switch is triggered, and when the accumulated time is greater than a predefined time value, and the switch is not triggered again, the controller re-generates the second signal, and wirelessly broadcasts the second signal via the wireless transceiver.

5. The device of claim 1, further comprising at least one motion sensor for detecting a motion or posture, wherein the controller determines whether the detected motion or posture conforms to a specific motion or posture, when the detected motion or posture conforms to the specific motion or posture, the controller generates a third signal comprising the specific service ID, the identification data corresponding to the device, and third content data, and wirelessly broadcasts the third signal via the wireless transceiver.

6. The device of claim 1, further comprising a power unit, wherein the controller obtains a remaining battery level corresponding to the power unit, and determines whether the remaining battery level is less than a predefined level, when the remaining battery level is less than the predefined level, the controllers generates a fourth signal comprising the specific service ID, the identification data corresponding to the device, and fourth content data, and wirelessly broadcasts the fourth signal via the wireless transceiver.

7. The device of claim 1, wherein a target electronic device wirelessly receives the first signal via a wireless transceiver, and determines whether the specific service ID in the first signal conforms to a predefined service ID, when the specific service ID conforms to the predefined service ID, the first content in the first signal is presented via the target electronic device.

8. The device of claim 1, further comprising a reading unit, wherein after the first signal is broadcasted, the controller instructs the reading unit to be active for reading an identify code from a data carrier.

9. A method for generating service requests, for use in a device, comprising:
detecting the presence of an object by a sensor;
determining whether the object is continuously present for a predefined interval when the object is present;
generating a first signal comprising a specific service ID, identification data corresponding to the device, and first content data when the object is continuously present for the predefined interval; and
wirelessly broadcasting the first signal via a wireless transceiver.

10. A machine-readable storage medium comprising a computer program, which, when executed, causes a device to perform a method for generating service requests, wherein the method comprises:
detecting the presence of an object by a sensor;
determining whether the object is continuously present for a predefined interval when the object is present;
generating a first signal comprising a specific service ID, identification data corresponding to the device, and first content data when the object is continuously present for the predefined interval; and
wirelessly broadcasting the first signal via a wireless transceiver.
